(19) United States
(12) Patent Application Publication
(10) Pub. No.: US 2022/0398619 A1
(43) Pub. Date: Dec. 15, 2022

(54) A METHOD FOR CREDIT CARD INTEGRATION WITHIN A PRODUCT TREE BASED MULTI-LEVEL MARKETING SYSTEM

(71) Applicant: KwikClick, LLC, Murray, UT (US)

(72) Inventor: Fred Cooper, Farmington, UT (US)

(21) Appl. No.: 17/825,973

(22) Filed: May 26, 2022

Related U.S. Application Data
(60) Provisional application No. 63/193,265, filed on May 26, 2021.

(51) Int. Cl. G06Q 30/02

(52) U.S. Cl. CPC G06Q 30/0214; G06Q 30/0215

(57) ABSTRACT

Disclosed herein is a system and method to allow sellers of products to enroll a credit card in a multi-level marketing (MLM) system by providing the MLM system with a seller and a credit card to be issued and provides a first applicant to sign up for that credit card and then allow the purchaser to enroll themselves in the MLM system as well as to allow the credit card holder to easily advertise the credit card to a second applicant. The second applicant can do the same, by applying for a credit card and, assuming they are approved, advertising to a third person and so on. Commission is payed to the upline card holders based on transaction made by the persons they referred at preset commission levels. Once the card holders are enrolled, they are provided with a code, to refer other users. The card holding users can pass the code via link onto the user's followers, such as family, friends, colleagues, etc. to allow them to become part of the MLM tree. The system also acts as a credit card company which allows the system to collect data on user purchases and collect interest on credit card debt. Further, any credit card, whether issued by the MLM system or by another party, can be registered with the system just like any other product and commission can be paid upline whenever a user makes a credit card transaction.

### CROSS-REFERENCE TO RELATED APPLICATION

The present application claims the priority benefit of U.S. provisional application No. 63/193,265 filed May 26, 2021, the disclosure of which is incorporated herein by reference.

### FIELD OF THE DISCLOSURE

The present disclosure is generally related to multi-level marketing systems and commissions offered to users.

### BACKGROUND

A Multilevel marketing (MLM) system is a sales strategy used by some direct sales companies, which is used to encourage existing distributors to recruit new distributors who are paid a percentage of their recruits' sales. The recruits are the distributor's “downline.” Distributors also make money through direct sales of products to customers. Amway, which sells health, beauty, and home care products, is an example of a well-known direct sales company that uses multilevel marketing.

Multilevel marketing is a legitimate business sales strategy. One problem is that the MLM is organized as a pyramid tree. However, pyramid “schemes” that use money from new recruits to pay people at the top rather than those who perform the work is illegal. These pyramid schemes involve taking advantage of people by pretending to be engaged in legitimate multilevel or network marketing. You can spot pyramid schemes by their greater focus on recruitment than on product sales.

One issue in determining the legitimacy of a multilevel marketing company is whether it sells its products primarily to consumers or to its members who must recruit new members to buy their products. If it is the former, the company is likely a legitimate multilevel marketer. If it is the latter, it could be an illegal pyramid scheme.

Although each MLM company dictates its own specific financial compensation plan for the payout of any earnings to their respective participants, the common feature that is found across all MLMs is that the compensation plans theoretically pay out to participants only from two potential revenue streams. The first is paid out from commissions of sales made by the participants directly to their own retail customers. The second is paid out from commissions based upon the wholesale purchases made by other distributors below the participant who have recruited those other participants into the MLM; in the organizational hierarchy of MLMs, these participants are referred to as one's down line distributors.

MLM salespeople (distributors) are, therefore, expected to sell products directly to end-user retail consumers by means of relationship referrals and word of mouth marketing, but most importantly they are incentivized to recruit others to join the company's distribution chain as fellow salespeople so that these can become down line distributors.

*Credit cards are often used to purchase products online because of the inconvenience of using cash, check, or money order for online products. While many MLM systems accept credit cards for products and might even encourage their use, no MLM uses the credit card itself as a product on which upline users may receive commission. *Further, credit card companies have access to a wealth of information about credit card user's buying habits which would be extremely useful for an MLM system to have, however, many of these companies keep this information proprietary or offer analytics services that make use of this data at a high price. *Currently, there is no MLM system that concurrently acts as a credit card clearing house which allows users to make purchases on credit which the MLM system pays to the 3rd party vendor and the charges the user on their credit card debt after some amount of time. The MLM can also collect interest on the user's debt. This credit card and other companies credit cards can also be items within the MLM system with a portion of the interest, payments, and/or purchases being payed upline. *This system allows the MLM system to integrate with existing credit card system which not only provides more robust information on user purchase, ultimately leading to more accurate product trees, but allow the MLM system to itself become a credit card company and further simplify purchasing products and receiving commissions for users.

### DESCRIPTIONS OF THE DRAWINGS

FIG. 1: Illustrates a Multi-Level Marketing System.

FIG. 2: Illustrates an Admin Network Base Module.

FIG. 3: Illustrates an Admin Network Calculation Module.

FIG. 4: Illustrates an Admin Network Commission Module.

FIG. 5: Illustrates an Admin Network Advertising Module.

FIG. 6: Illustrates an Admin Network Admin Database.

FIG. 7: Illustrates an Admin Network Vendor Module.

FIG. 8: Illustrates an Admin Network Compensation Database.

FIG. 9: Illustrates an Admin Network Code Database.

FIG. 10: Illustrates an Admin Network CC Company Module.

FIG. 11: Illustrates an Admin Network CC Approval Module.

FIG. 12: Illustrates an Admin Network CC Commission Module.

FIG. 13: Illustrates an Admin Network CC Purchase Module.

FIG. 14: Illustrates an Admin Network CC Interest Module.

FIG. 15: Illustrates an Admin Network CC Payment Module.

FIG. 16: Illustrates an Admin Network CC User Account Module.

FIG. 17: Illustrates an Admin Network CC User Database.

FIG. 18: Illustrates an Admin Network CC Transaction Database.

FIG. 19: Illustrates an Admin Network CC Commission Database.

FIG. 20: Illustrates a User Device Purchase Module.

FIG. 21: Illustrates a User Device User Database.

FIG. 22: Illustrates a User Device Downline Module.

FIG. 23: Illustrates a User Device CC Sign-up Module.

FIG. 24: Illustrates a User Device CC Portal Module.

FIG. 25: Illustrates a 3rd Party Network 3rd Party Base Module.

FIG. 26: Illustrates a 3rd Party Network Admin Module.

FIG. 27: Illustrates a 3rd Party Network Discount Module.

FIG. 28: Illustrates a 3rd Party Network 3rd Party Database.

FIG. 29: Illustrates a Credit Card Company To Admin Module.

FIG. 30: Illustrates a Credit Card Company Accounting Database.

FIG. 31: Illustrates a Credit Card Company Card Holder Database.

### DETAILED DESCRIPTION

FIG. 1 is a system for a Multi-Level Marketing System. This system comprises of *an Admin Network which includes an Admin Network Base Module 104, Admin Network Calculation Module 106, Admin Network Commission Module 108, Admin Network Advertising Module 110, Admin Network Admin Database 112, Admin Network Vendor Module 114, Admin Network Compensation Database 116, an Admin Network Code Database 118, an Admin Network CC Company Module 120, an Admin Network CC Approval Module 122, an Admin Network CC Commission Module 124, an Admin Network CC Purchase Module 126, an Admin Network CC Interest Module 128, an Admin Network CC Payment Module 130, an Admin Network CC User Account Module 132, an Admin Network CC User Database 134, an Admin Network CC Transaction Database 136, and an Admin Network CC Commission Database 138. In some embodiments, a distributor may refer to the non-salaried workforce selling the company's products or services, while the earnings of the participants are derived from a pyramid-shaped or binary compensation commission system. In some embodiments, a product may refer to an article or substance that is manufactured or refined for sale. In some embodiments, a service may refer to a system supplying a public need such as transport, communications, or utilities such as electricity or water. A service may be an act of dealing with a customer in a store, restaurant, or hotel by taking their orders, showing, or selling them goods. Additionally, a service may be work that someone does or time that someone spends working for an organization, or a business that offers a particular type of help or work. In some embodiments, an MLM tree or commission tree may refer to the payment structure in which commissions are given out. In some embodiments, a MLM system may be referred to as network marketing which may be a business model that depends on person-to-person sales by independent representatives, often working from home. A network marketing business may require the independent representatives to build a network of business partners or salespeople to assist with lead generation and closing sales. In some embodiments, end of life of MLM tree may refer to the end of the MLM tree in which further participants in the MLM will not receive a commission, the commission tree starts up again, or the commission tree is restructured in some form. In some embodiments, an existing MLM system may refer to currently existing or established companies that use the sales strategies to encourage existing distributors to recruit new distributors who are paid a percentage of their recruits' sales. In some embodiments, the Admin Network may include data security as well as an MLM algorithm and may be able to connect to the app store. In some embodiments, data security may refer to the process of protecting data from unauthorized access and data corruption throughout its lifecycle. Data security may include data encryption, tokenization, and key management practices that protect data across all applications and platforms. In some embodiments, MLM algorithm may refer to the calculation performed using the compensation decay rate in order to calculate the commissions for downline participants. In some embodiments, connect app store refers to connecting the app store to an MLM system, at element 102. An Admin Network Base Module 104 which connects to the 3rd Party Network 3rd Party Base Module 160, initiates the Admin Network Vendor Module 114 and initiates the Admin Network Calculation Module 106. The 3rd Party Network 3rd Party Base Module 160 is the module that interacts with the sellers and the Admin Network Vendor Module 114 is the module that is loaded on the seller's computers system, at element 104. An Admin Network Calculation Module 106 which is initiated by the Admin Network Base Module 104, extracts the discount received from the 3rd Party Network 3rd Party Base Module 160 as well as the compensation plan or commission plan (e.g. its decay rate or commission structure so that each downline gets less and less commission) in order to determine the commissions for the MLM (Multi-Level Marketing) tree and stores the data in the Admin Network Compensation Database 116. In some embodiments, a commission may refer to a payment to someone who sells goods that is directly related to the amount sold, or a system that uses such payments. In some embodiments, a compensation plan or a commission plan may refers to the decay rate of the commissions provided to the MLM system from the discount offered by the 3rd Party, the 3rd Party also selects the decay rate in order to calculate the commissions offered to the first purchaser as well as the percentage offered to the downline participants, at element 106. An Admin Network Commission Module 108 which is continuously polling for the user data (the user being the product purchaser/distributor) from the 3rd Party Network Discount Module 164 and once it receives the data the Admin Network Commission Module 108 uses the data stored in the Admin Network Compensation Database 116 to determine the downline and upline commissions for the other users (product purchasers/distributors) within the MLM tree, and then initiates the Admin Network Advertising Module 110. In some embodiments, an upline may refer to the MLM distributors that recruits work for as salespeople to sell the products or services. In some embodiments, a downline may refer to the recruits the MLM distributors are able to secure as participants in the MLM system. In some embodiments, downline trees may go across country boundaries which may be the ability to pay out commissions for an MLM tree even though the participants in the MLM tree may not reside in the same country. In this case the commissions would need to be calculated for the appropriate exchange rate to ensure participants are paid in their residing countries currency in the correct amount, at element 108. An Admin Network Advertising Module 110, which is initiated by the Admin Network Commission Module 108, determines the user's (product purchasers/distributors) sphere of influence or contact list in order to provide the user's potential downline purchasers/distributors with a link and a code for the potential downline purchasers/distributors to become part of the MLM tree, at element 110. An Admin Network Admin Database 112, which is created through the Admin Network Vendor Module 114 (seller of a product), contains the data received from various 3rd Parties (various sellers) that are part of the MLM, the data may contain an item ID, description of the item, the original cost of the item, the discount for the item, the cost of the item with the discount, the compensation plan decay rate and a link to the item. In some embodiments, advertising link may refer to a link that directs a consumer to a product, service or good, at element 112. An Admin Network Vendor (those selling products) Module, which is initiated by the Admin Network Base Module 104, receives the data from the 3rd Party Network, stores the data in the Admin Network Admin Database 112, creates a link for the item and sends the link back to the 3rd Party Network and returns to the Admin Network Base Module 104, at element 114. An Admin Network Compensation Database 116, which is created through the Admin Network Calculation Module 106 and contains the various commissions for the different product purchasers/distributors, at element 116. An Admin Network Code Database 118 which contains the codes given to the product purchasers/distributors (users) for the product purchasers/distributors (user) to pass the code to their potential purchasers/distributors to advertise or promote the item that the user has purchased, at element 118. *An Admin Network CC Company Module 120 which receives data from the Credit Card Company To Admin Module 172 on users who signed up for an out-of-network credit card using a code from the code database, which is stored in the Admin Network CC User Database 134, and transactions made by those users, from or to their out-of-network credit card, which are stored in the Admin Network CC Transaction Database 136, at element 120. *An Admin Network CC Approval Module 122 which receives data from the User Device CC Sign-up Module 152, that data is either approved or denied via an approval process which may be manual or automatic. If approved, credit card information is generated for the user and the generated data and the data received from the User Device CC Sign-up Module 152 are stored in the Admin Network CC User Database 134, in some embodiments this may automatically trigger a physical credit card being sent to the user address which would likely be required as part of the approval process, at element 122. *An Admin Network CC Commission Module 124 which polls for new data in the Admin Network CC Transaction Database 136, extracts the new data, checks the Admin Network CC Commission Database 138 for the commission plan for that credit card company, calculates the commission to upline users, searches for the extracted user ID to find the upline users, then pays the calculated commission to the upline users, at element 124. *An Admin Network CC Purchase Module 126 which receives data on in-network credit card purchases from the 3rd Party Network Discount Module 164, makes a payment to the 3rd party that the purchase was made from, then stores the payment data in the Admin Network CC Transaction Database 136, at element 126. *An Admin Network CC Interest Module 128 which polls the Admin Network CC Transaction Database 136 on a period schedule, calculates each user's debt, calculates an interest charge on that debt based on an interest rate, and stores that interest charge in the Admin Network CC Transaction Database 136, at element 128. *An Admin Network CC Payment Module 130 which receives payment information from the User Device CC Portal Module 154, verifies the payment funds are valid, then stores the payment in the Admin Network CC Transaction Database 136, at element 130. *An Admin Network CC User Account Module 132 which receives requests for user transaction information from the User Device CC Portal Module 154, extract the user's transaction data from the Admin Network CC Transaction Database 136, then sends the data back to the User Device CC Portal Module 154, at element 130. *An Admin Network CC User Database 134 which stores information about users who have a credit card including user ID, billing information, credit card number, credit card expiration date, CVC, code used to sign up, credit card company, and any other identifying information which may be used as part of a credit card application process or is usually collected by credit card companies, at element 132. *An Admin Network CC Transaction Database 136 which stores transactions made by users with credit cards, transactions may include a user ID, credit card number, time and data, type of transaction, transaction amount, whether the transaction is pending, whether the transaction was made using an in-network or out-of-network credit card, or any other metric which is usually collected by credit card companies in regards to credit card purchases, payments, or interest fees, at element 134. *An Admin Network CC Commission Database 138 which stores commission plans for each individual credit card company, the plans may treat each type of transaction differently, for example, payments may have a different commission structure than purchases, in some embodiments commission plans may be separated by card type (visa, Mastercard, AmEx), item ID, user ID, sign-up date, etc. at element 136. The Cloud or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance, at element 138. A User (product purchasers/distributors) Device such as a laptop, smartphone, table, computer, or smart speaker, at element 140. The User Device Comms or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance, at element 142. A User Device Purchase Module 146 which connects to the 3rd Party Network, allows a purchaser/distributor to select an item and the associated link, determines if the purchaser/distributor entered a code, and sends the link and code, if available, to the 3rd Party Network, at element 144. A User Device User Database 148 which contains the user's (product purchasers/distributors) followers (sphere of influence) as well as the followers contact information in order for them to receive commissions on their purchases. In some embodiments, a distributor contact list or followers may refer to the recruits or followers on social media that a distributor has secured to participant in their downline. In some embodiments, the User Device User Database 148 may include ratings and recommendations from the users. In some embodiments, rating and recommendation modules may refer to modules in which a company, entity, or person provides ratings and/or recommendations for products, goods, or services, at element 146. A User Device Downline Module 150 which is continuously polling to receive the code and link from the Admin Network Advertising Module 110 to allow the purchaser/distributor to pass the code and link to the user's followers stored in the User Device User Database 148, at element 148. *A User Device CC Sign-up Module 152 which allows a user to enter data into an application to be approved for an in-network credit card, this data is sent to the Admin Network CC Approval Module 122, in an embodiment the User Device CC Sign-up Module 152 may also be used to apply for out-of-network credit cards, at element 150. *A User Device CC Portal Module 154 allows a user to view their in-network credit card statement and make payments on their credit card debt, at element 152. A 3rd Party Network which is the various 3rd Parties, such as retail stores including stores that sell product consumables, services, franchises, service networks, large box stores, or e-commerce sites that allow e-commerce sales and may include an e-commerce shopping cart, that offer items to users at a discount, such as a product discount, in order to use MLM. In some embodiments, a franchise may refer to an authorization granted by a government or company to an individual or group enabling them to carry out specified commercial activities, e.g. providing a broadcasting service, or acting as an agent for a company's products. In some embodiments, product consumables may refer to goods by individuals and businesses that must be replaced regularly because they wear out or are used up. In some embodiments, service networks refer to a collection of people and information brought together on the internet to provide a specific service or achieve a common business objective, such as Angie's List. In some embodiments, e-commerce sale may refer to sales of goods and services where the business takes place over the internet, an extra-net, Electronic Data Interchange (EDI), or other online system. Payment may or may not be made online. Business in this context is defined as an order placed by the buyer or price and terms of sale negotiated. In some embodiments, e-commerce shopping cart may refer to a software used in E-commerce to assist visitors to make purchases online. Upon checkout, the software calculates the total of the order, including shipping and handling, taxes and other parameters the owner of the site has previously set. In some embodiments, retailer may refer to a person or business that sells goods to the public in relatively small quantities for use or consumption rather than for resale. In some embodiments, product discounts may refer to a reduce price or something being sold at a price lower than that item is normally sold for. It is a reduction to a basic price for a good or service. In some embodiments, large box stores may refer to a physically large retail establishment, usually part of a chain of stores, offers a variety of products to its customers. The term sometimes refers, by extension, to the company that operates the store, and may be referenced as a supercenter, superstore, megastore, etc. These stores achieve economies of scale by focusing on large sales volumes. Because volume is high, the profit margin for each product can be lowered, which results in very competitively priced goods. The term “big-box” is derived from the store's physical appearance, at element 154. The 3rd Party Network Comms or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance, at element 156. A 3rd Party Network 3rd Party Base Module 160 which initiates the 3rd Party Network Admin Module 162, continuously polls for the user to select a link, receives the purchaser/distributor data, and initiates the 3rd Party Network Discount Module 164, at element 158. A 3rd Party Network Admin Module 162 which is initiated from the 3rd Party Network Base Module, connects to the Admin Network, sends the data for the items to be purchased, receives a link from the Admin Network, stores the link in the 3rd Party Network Database and returns to the 3rd Party Network 3rd Party Base Module 160, at element 160. *A 3rd Party Network Discount Module 164 which is initiated from the 3rd Party Network 3rd Party Base Module 160, extracts the link and compares it to the 3rd Party Network 3rd Party Database 166 to extract the corresponding discount for the selected item, the discount is applied to the user order and it is determined if the user entered a code or not, the order is processed and the process returns to the 3rd Party Network 3rd Party Base Module 160, if the user used an in-network credit card then that information is sent to the Admin Network CC Purchase Module 126 for verification and if verified, the transaction data is stored in the Admin Network CC Transaction Database 136, at element 162. A 3rd Party Network 3rd Party Database 166 which contains information about the item the 3rd Party selects to offer at a discount for the Admin Network. In some embodiments, the 3rd Party Network 3rd Party Database 166 may include local media for the product or service. In some embodiments, local media may refer to the various types of media, such as photos, videos, text, sounds, haptics, online product descriptions, etc. for enhanced marketing, at element 164. *A Credit Card Company which may be a bank, clearing house, retail business, or any other institution which may issue a credit card and collects data on that credit card's holder and the transactions made with that credit card. Credit cards provided by these companies are considered to be out-of-network credit cards since the Admin Network does not control the credit card approval process or handle the transactions made via the credit card. In some embodiments a Credit Card Company may also offer products and services that are not related to credit cards or credit. In some embodiments a Credit Card Company may also be a 3rd Party. In some embodiments the Admin Network and a Credit Card Company may be the same entity in which case credit cards issued by the co-owned Credit Card Company may be considered in-network credit cards, in an embodiment where the Credit Card Company is also a bank a user who is referred for banking services and uses a code from the code database may automatically have that code applied when they apply for a credit card from that bank, at element 166. *A Credit Card Company Comms or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance, at element 168. *A Credit Card Company To Admin Module 172 which polls for new data in the Credit Card Company Accounting Database 174 or Credit Card Company Card Holder Database 176 and sends that data to the Admin Network CC Transaction Database 136 or Admin Network CC User Database 134 respectively, at element 170. *A Credit Card Company Accounting Database 174 which contains transactions made by users who obtained a credit card from the Credit Card Company using a referral code from the Admin Network Code Database 118, at element 172. *A Credit Card Company Card Holder Database 176 which contains the credit card information and personal information of users who obtained a credit card from the Credit Card Company using a referral code from the Admin Network Code Database 118, at element 174.

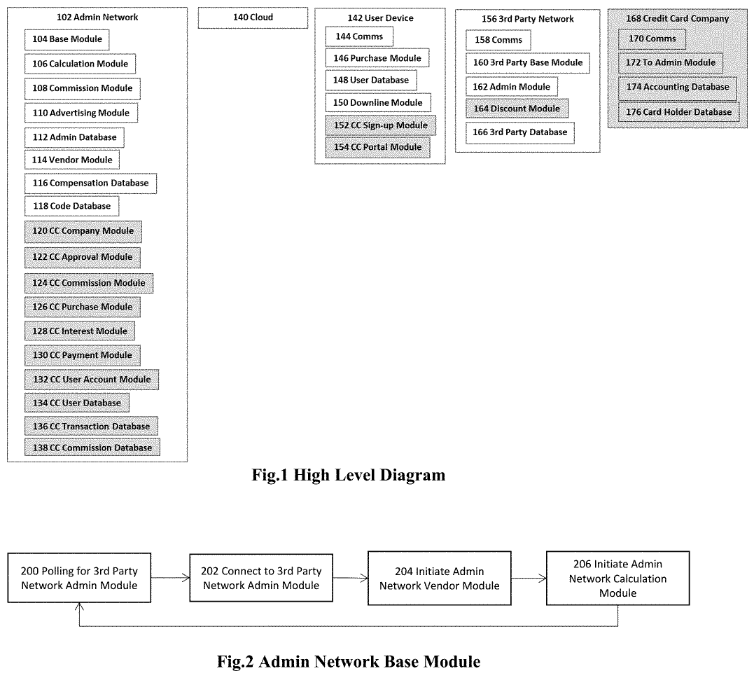

Functioning of the Admin Network Base Module 104 will now be explained with reference to FIG. 2. The process begins with the Admin Network Base Module 104 continuously polls for the 3rd Party Network Admin Module 162 (sellers of products), at step 200. The Admin Network Base Module 104 connects to the 3rd Party Network Admin Module 162 (sellers of products), at step 202. Once the Admin Network Base Module 104 connects to the 3rd Party Network Admin Module 162 the Admin Network Base Module 104 initiates the Admin Network Vendor Module 114, at step 204. Then the Admin Network Base Module 104 initiates the Admin Network Calculation Module 106 and the process returns to step 200, at step 206.

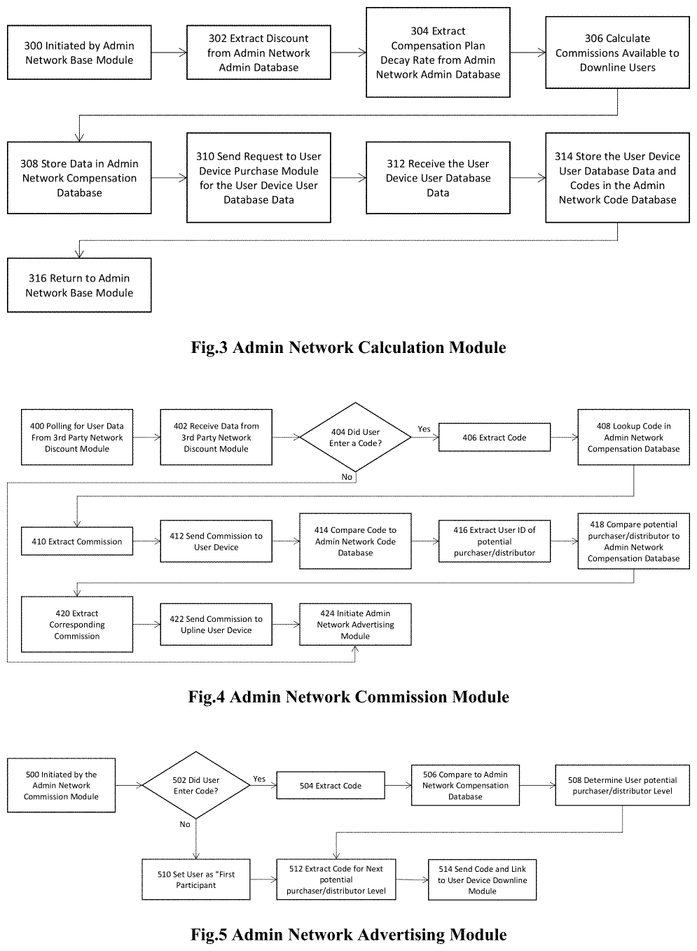

Functioning of the Admin Network Calculation Module 106 will now be explained with reference to FIG. 3. The process begins with the Admin Network Base Module 104 initiating the Admin Network Calculation Module 106, at step 300. The Admin Network Calculation Module 106 extracts the discount from the Admin Network Admin Database 112, which is received from the 3rd Party Network, at step 302. Then the Admin Network Calculation Module 106 extracts the compensation plan decay rate from the Admin Network Admin Database 112, at step 304. The Admin Network Calculation Module 106 determines the commissions available to the downline users, or the followers of the user that purchased the item. In some embodiments, the commissions may be calculated by using the discount on the item and providing 50% of the discount to the first participant and then the remaining amount of the discount for the downline users at a 50% decay rate. For example, if the first user purchased an item that was originally $59.00 discounted by 15%, the first user to make the purchase would receive $3.32 or 50% of the discount. Then any follower of the user who made the initial purchase would receive 50% of the remaining discount or 50% of $3.32, and this may continue until there is only one cent left to pay out as a commission for the downline users, at step 306. Then the Admin Network Calculation Module 106 stores the data in the Admin Network Compensation Database 116, at step 308. The Admin Network Calculation Module 106 sends a request to the User Device Purchase Module 146 for the data stored in the User Device User Database 148, at step 310. Then the Admin Network Calculation Module 106 receives the User Device User Database 148 data from the User Device Purchase Module 146, at step 312. The Admin Network Calculation Module 106 stores the received data, as well as the code data, in the Admin Network Code Database 118, at step 314. The Admin Network Calculation Module 106 then returns to the Admin Network Base Module 104, at step 316.

Functioning of the Admin Network Commission Module 108 will now be explained with reference to FIG. 4. The process begins with the Admin Network Commission Module 108 continuously polling for the user data from the 3rd Party Network Discount Module 164, at step 400. The Admin Network Commission Module 108 receives the user data from the 3rd Party Network Discount Module 164, at step 402. Then the Admin Network Commission Module 108 determines if the user entered a code, at step 404. If the user did enter a code the Admin Network Commission Module 108 extracts the code the user entered, at step 406. The extracted code is then looked up in the Admin Network Compensation Database 116 which contains the various commissions for the different sphere of influence or potential product purchasers/distributors levels as well as the associated code for each of the different sphere of influence levels, at step 408. Then the Admin Network Commission Module 108 extracts the corresponding commission for the code that was looked up in the Admin Network Compensation Database 116, at step 410. The Admin Network Commission Module 108 sends the commission to the user (purchaser/distributor). In some embodiments, the Admin Network Commission Module 108 may track profits and payments as well as track taxes for users enrolled in the MLM system. In some embodiments, track profits and payments may refer to the MLM system tracking the profits of the MLM and tracking the payments or commissions paid out to participants. In some embodiments, track taxes may refer to tracking the commissions provided to participants for tax purposes, at step 412. Then the Admin Network Commission Module 108 compares the extracted code to the Admin Network Code Database 118 which contains the list of users and the code sent to the user's followers, at step 414. The Admin Network Commission Module 108 extracts the user ID and sphere of influence or potential purchaser/distributor by using the extracted code, at step 416. Then the Admin Network Commission Module 108 compares the extracted sphere of influence or potential purchaser/distributor to the Admin Network Compensation Database 116, at step 418. The Admin Network Commission Module 108 uses the extracted sphere of influence to extract the corresponding commission from the Admin Network Compensation Database 116, at step 420. The Admin Network Commission Module 108 sends the commission to the upline user, at step 422. If the user did not enter a code, the Admin Network Commission Module 108 initiates the Admin Network Advertising Module 110, at step 424.

Functioning of the Admin Network Advertising Module 110 will now be explained with reference to FIG. 5. The process begins with the Admin Network Commission Module 108 initiating the Admin Network Advertising Module 110, at step 500. The Admin Network Advertising Module 110 determines if the user entered a code, at step 502. If it is determined that the user entered a code the code is extracted, at step 504. The Admin Network Advertising Module 110 compares the extracted code to the Admin Network Compensation Database 116, at step 506. The Admin Network Advertising Module 110 determines the user's sphere of influence level, at step 508. If it is determined that the user did not enter a code then the Admin Network Advertising Module 110 sets the user as the “First Participant”, at step 510. Then the Admin Network Advertising Module 110 extracts the code for the next sphere of influence level or potential purchaser/distributor in order to provide the user's followers with a code that would allow them to join the Multi-Level Marketing tree, at step 512. The Admin Network Advertising Module 110 sends code and the link to the item to the User Device Downline Module 150, at step 514.

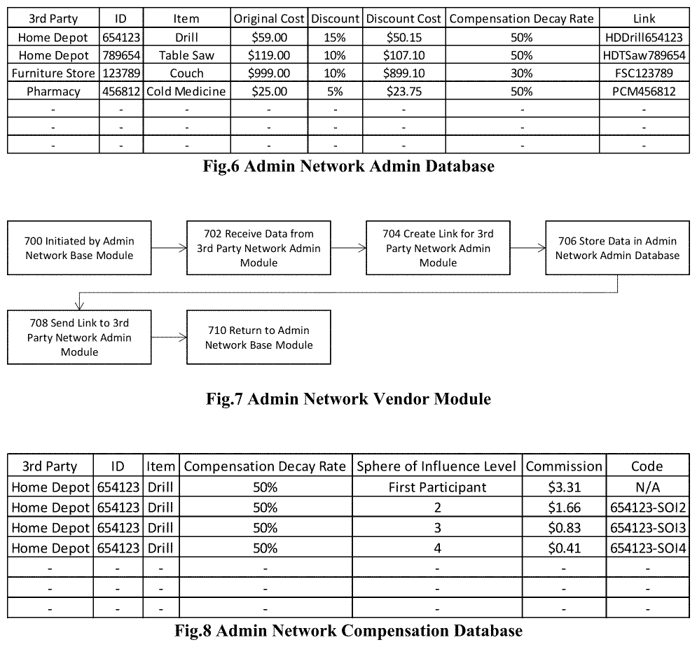

Functioning of the Admin Network Admin Database 112 will now be explained with reference to FIG. 6. This figure displays the Admin Network Admin Database 112 which is created through the Admin Network Vendor Module 114. The Admin Network Vendor Module 114 receives the item data from the 3rd Party Network, creates a link for the item, stores the data in the Admin Network Admin Database 112 and sends the created link back to the 3rd Party Network. The Admin Network Admin Database 112 contains the data collected from various 3rd Parties that enrolled in the Multi-Level Marketing System. The Admin Network Admin Database 112 contains the name of the 3rd Party, the ID for the item, an description of the item, the original cost of the item, the discount provided by the 3rd Party, the cost of the item with the discount, the compensation decay rate or how the downline commissions are calculated, and the link to the item. In some embodiments, the Admin Network Admin Database 112 may include communicating events with the downlines and uplines, dynamic incentives and rewards for a product, marketing materials, banking referrals, materials for suggestive selling, etc. In some embodiments, communicate events with downlines and uplines refer to advertising events to participants in an MLM system. In some embodiments, dynamic incentives and rewards for a product may refer to incentives or rewards that are continuously updated for a product. In some embodiments, marketing materials may refer to a means of marketing, advertising or promotional materials developed by or for license (or subject to licensee's approval) that promote the sale of the licensed product, including but not limited to, television, radio and online advertising, point of sale materials (e.g. posters, counter-cards), packaging advertising, print media and all audio or video media. In some embodiments, banking referral may refer to a structured flow of collecting and organizing referrals for banks. Businesses who have been unsuccessful in a credit application process with a bank will be asked for their permission to have their financial information passed to designated finance platforms who can contact the business in a regulated time-frame. In some embodiments, suggestive selling may refer to a sales technique where an employee asks a customer if they would like to include an additional purchase or recommends a product which might suit the client.

Functioning of the Admin Network Vendor Module 114 will now be explained with reference to FIG. 7. The process begins with the Admin Network Base Module 104 initiating the Admin Network Vendor Module 114, at step 700. The Admin Network Vendor Module 114 receives the data from the 3rd Party Network Admin Module 162 which may include the item to be enrolled in the MLM system, the original cost of the item, the discount provided by the 3rd Party, the cost of the item with the discount, the compensation plan decay rate, etc., at step 702. Then the Admin Network Vendor Module 114 creates a link for the item for the 3rd Party Network Admin Module 162. A vendor is a seller of a product, such as a retailer, at step 704. The Admin Network Vendor Module 114 stores the received data and the created link in the Admin Network Admin Database 112, at step 706. The Admin Network Vendor Module 114 sends the link to the 3rd Party Network Admin Module 162, at step 708. The Admin Network Vendor Module 114 returns to the Admin Network Base Module 104, at step 710.

Functioning of the Admin Network Compensation Database 116 will now be explained with reference to FIG. 8. This figure displays the Admin Network Compensation Database 116 which is created through the Admin Network Calculation Module 106. The Admin Network Calculation Module 106 extracts the discount and the compensation plan decay rate in order to calculate the downline commissions for additional users and the various sphere of influence levels are stored in the Admin Network Compensation Database 116. The Admin Network Compensation Database 116 contains the 3rd Party, the ID for the item, the item, the compensation plan decay rate, the various sphere of influence levels, the commission for each sphere of influence level and the code to be used by the user's followers to enroll in the MLM system. In some embodiments, the Admin Network Compensation Database 116 may include a lottery structure for how the commissions are paid to users or freelancers. In some embodiments, lottery may refer to a process or thing whose success or outcome is governed by chance. A means of raising money by selling number tickets and giving prizes to the holders of number drawn at random. In some embodiments, freelancers may refer to a person who works as a writer, designer, performer, or the like, selling work or services by the hour, day, job, etc., rather than working on a regular salary basis for one employer.

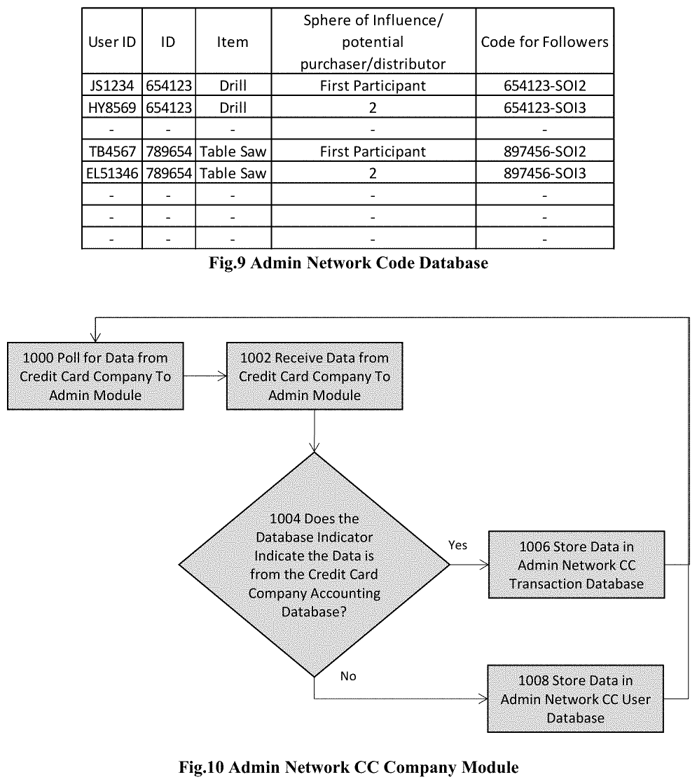

Functioning of the Admin Network Code Database 118 will now be explained with reference to FIG. 9. The Admin Network Code Database 118 which is used to determine the sphere of influence of the purchaser/distributor from the code that was used when a purchaser/distributor purchased a product or item from a 3rd Party. The Admin Network Code Database 118 contains User ID, ID, Item, Sphere of Influence/potential purchaser/distributor, and Code for Followers.

Functioning of the Admin Network CC Company Module 120 will now be explained with reference to FIG. 10. *The process begins with the Admin Network CC Company Module 120 polling for data from the Credit Card Company To Admin Module 172, which contains at least an indicator of which database the data originated from, for example “1” for the Credit Card Company Accounting Database 174 and “0” for the Credit Card Company Card Holder Database 176, at step 1000. *The Admin Network CC Company Module 120 receives the data from the Credit Card Company To Admin Module 172, for example, entries from the Credit Card Company Accounting Database 174, at step 1002. *The Admin Network CC Company Module 120 determines if the database indicator sent with the data indicates that the data originated in the Credit Card Company Accounting Database 174, for example, the indicator may be “1” for the Credit Card Company Accounting Database 174 and “0” for the Credit Card Company Card Holder Database 176, the Admin Network CC Company Module 120 would then interpret “1” as the statement TRUE in binary and determine that the database indicator is indicating that it is true that the data originated in the Credit Card Company Accounting Database 174, as such the database indicator is a Boolean variable with a value of 1 or 0, or TRUE or FALSE, which the Admin Network CC Company Module 120 uses as the argument of an IF statement in the computer code, if the IF statement returns a value of TRUE then the Admin Network CC Company Module 120 executes step 1006, if the IF statement returns a value of FALSE then the Admin Network CC Company Module 120 will execute step 1008, in some embodiments the Credit Card Company may have more than two databases and the Admin Network CC Company Module 120 may include additional steps to determine which database on the Admin Network the data will ultimately be stored in, in which case the computer code will need to user either nested IF statements or a SWITCH statement, at step 1004. *If the database indicator sent with the data indicates that the data originated in the Credit Card Company Accounting Database 174, the Admin Network CC Company Module 120 stores the data in the Admin Network CC Transaction Database 136, this data is data on user transactions which include payments, purchases, and interest, at step 1006. *If the database indicator sent with the data indicates that the data originated in the Credit Card Company Card Holder Database 176, the Admin Network CC Company Module 120 stores the data in the Admin Network CC User Database 134, this data is user data which contains a user's personal information so that the credit card can be tied to the user, at step 1008.

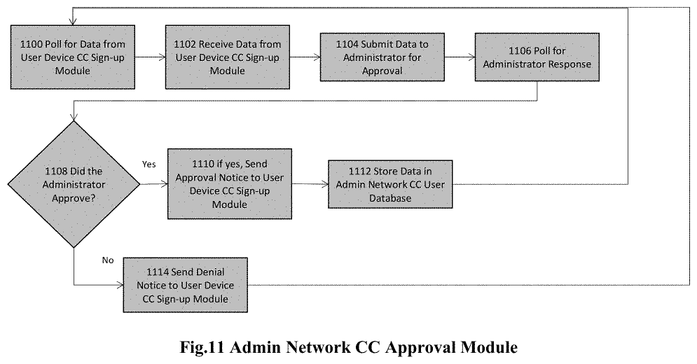

Functioning of the Admin Network CC Approval Module 122 will now be explained with reference to FIG. 11. *The process begins with the Admin Network CC Approval Module 122 polling for data from the User Device CC Sign-up Module 152, for example, the user's user ID, billing address, full name, social security number, and other information which is usually required to apply for a credit card, at step 1100. *The Admin Network CC Approval Module 122 receives data from the User Device CC Sign-up Module 152, for example, the user's user ID, billing address, full name, social security number, and other information which is usually required to apply for a credit card, at step 1102. *The Admin Network CC Approval Module 122 sends the data to an administrator to be approved, an administrator may be, for example, an owner of the Admin Network, a person hired to handle credit card approval, or an independent entity that handles credit card approval, in an embodiment the data is sent to another module which approves or denies an application for a credit card automatically, the data may be displayed on a GUI as part of the Admin Network or may be sent to an administrator via email, text, fax, etc., at step 1104. *The Admin Network CC Approval Module 122 polls for a response from the administrator, in an embodiment more than one administrator response may be required before the module continues, at step 1106. *The Admin Network CC Approval Module 122 determines if the administrator approved the credit card application, at step 1108. *If the administrator approved the credit card application, the Admin Network CC Approval Module 122 sends a notice of approval to the User Device CC Sign-up Module 152, for example, “You've been approved!” or “Sign-up Successful.”, at step 1110. *The Admin Network CC Approval Module 122 stores the credit card application data in the Admin Network CC User Database 134, for example, the user's user ID, billing address, full name, social security number, and other information which is usually required to apply for a credit card, at step 1112. *If the administrator denied the credit card application, the Admin Network CC Approval Module 122 sends a notice of denial to the User Device CC Sign-up Module 152, for example, “You've been denied.” or “Application error, please try again.”, at step 1114.

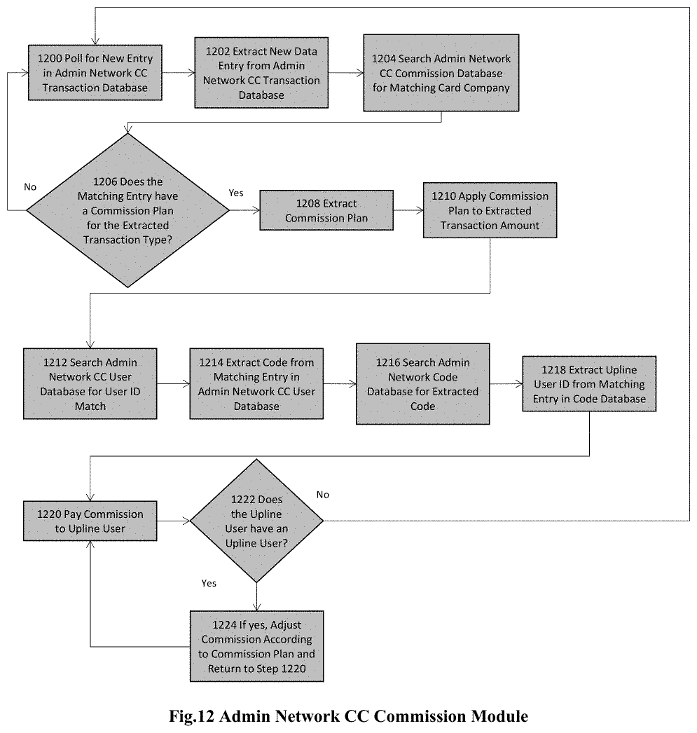

Functioning of the Admin Network CC Commission Module 124 will now be explained with reference to FIG. 12. *The process begins with the Admin Network CC Commission Module 124 polling for a new entry in the Admin Network CC Transaction Database 136, the entry includes, for example, a user ID, for example, JS1234, credit card number, for example, 9064 9598 7639 1030, time and date, for example, 6/19/2020 11:30:00 AM, type of transaction, for example an interest charge, transaction amount, for example, $3.21, whether the transaction is pending, whether the transaction was made using an in-network or out-of-network credit card, or any other metric which is usually collected by credit card companies in regards to credit card purchases, payments, or interest fees, at step 1200. *The Admin Network CC Commission Module 124 extracts all the data in the new entry in the Admin Network CC Transaction Database 136, the entry includes, for example, a user ID, for example, JS1234, credit card number, for example, 9064 9598 7639 1030, time and date, for example, 6/19/2020 11:30:00 AM, type of transaction, for example an interest charge, transaction amount, for example, $3.21, whether the transaction is pending, whether the transaction was made using an in-network or out-of-network credit card, or any other metric which is usually collected by credit card companies in regards to credit card purchases, payments, or interest fees, at step 1202. *The Admin Network CC Commission Module 124 searches the Admin Network CC Commission Database 138 for an entry that matches the credit card company from the extracted data, at step 1204. *The Admin Network CC Commission Module 124 determines if the matching entry has a commission plan for the type of transaction extracted, for example, if the extracted transaction type is “Purchase” then the Admin Network CC Commission Module 124 which check if the matching entry contains a commission plan for purchases under the purchase commission plan category, if no plan is found then the credit card company does not offer commission on this type of transaction and the Admin Network CC Commission Module 124 returns to polling for another new entry in the Admin Network CC Transaction Database 136, at step 1206. *If the matching entry has a commission plan for the type of transaction extracted, the Admin Network CC Commission Module 124 extracts that commission plan from the Admin Network CC Commission Database 138, commission plans contain a set of instructions to calculate commission, for example:

If (purchase Amount <= 50)
commission = Purchase Amount * 0.02f
else if (purchase_Amount > 50 && purchase_Amount <= 1000)
commission = (purchase_Amount - 50) * 0.01f + 1
else
commission = purchase_Amount * (0.01f / log(purchase_Amount)) + 11

purchase_Amount being the value of the extracted data from the amount category, at step 1208. *The Admin Network CC Commission Module 124 applies the commission plan to the extracted transaction amount, for example, if the commission plan is 2% of the amount with a decay rate of 50% then the first commission to the direct upline user would be 2% of the transaction amount, the user upline of that user would receive 2% multiplied by 50% or 1% of the transaction amount, etc., in some embodiments the commission plan may be a simple equation which the Admin Network CC Commission Module 124 enters the transaction amount into to get the commission, in other embodiments the commission plan may be so complex as to require a set of instructions which the Admin Network CC Commission Module 124, any maybe other modules, are able to execute, at step 1210. *The Admin Network CC Commission Module 124 searches the Admin Network CC User Database 134 for a user ID in the user ID category that matches the user ID in the extracted transaction data, at step 1212. *The Admin Network CC Commission Module 124 extracts the code from the entry that matches the extracted user ID from the Admin Network CC User Database 134, at step 1214. *The Admin Network CC Commission Module 124 searches the Admin Network Code Database 118 for the extracted code in the code for follower's category, at step 1216. *The Admin Network CC Commission Module 124 extracts the upline user's user ID from the entry that matches the code extracted from the Admin Network CC User Database 134, at step 1218. *The Admin Network CC Commission Module 124 pays the commission, in an embodiment this payment may be made in credit and stored as a transaction in the Admin Network CC Transaction Database 136, at step 1220. *The Admin Network CC Commission Module 124 determines if the upline user also has an upline user by determining if the sphere of influence in the Admin Network Code Database 118 for that user is “first participant” or not, if the user has no upline users then the Admin Network CC Commission Module 124 returns to polling for a new entry in the Admin Network CC Transaction Database 136, at step 1222. *If the upline user also has an upline user, the Admin Network CC Commission Module 124 adjusts the commission according to the commission plan and returns to step 1220, for example, if the commission plan is a decay rate plan then the commission would be reduced by the decay rate, at step 1224.

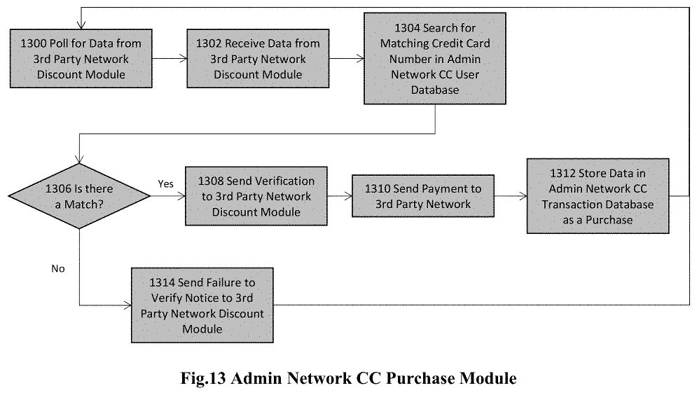

Functioning of the Admin Network CC Purchase Module 126 will now be explained with reference to FIG. 13. *The process begins with the Admin Network CC Purchase Module 126 polling for data from the 3rd Party Network Discount Module 164, which includes at least a credit card number and purchase amount but may also include expiration date, CVC, billing information, etc., at step 1300. *The Admin Network CC Purchase Module 126 receives data from the 3rd Party Network Discount Module 164, which includes at least a credit card number and purchase amount but may also include expiration date, CVC, billing information, etc., at step 1302. *The Admin Network CC Purchase Module 126 searches the Admin Network CC User Database 134 for a Credit Card Number in the Credit Card Number category that matches the Credit Card Number in the data from the 3rd Party Network Discount Module 164, in some embodiments the expiration date, CVC, billing information, some other data parameter, or any combination of these parameters may also have to match, at step 1304. *The Admin Network CC Purchase Module 126 determines if there is a matching entry in the Admin Network CC User Database 134, at step 1306. *If there is a matching entry in the Admin Network CC User Database 134, the Admin Network CC Purchase Module 126 sends a verification notice to the 3rd Party Network Discount Module 164, in an embodiment a verification notice is a simple Boolean true or false statement, in other embodiments it may include other data which may include message for the user or the 3rd Party Network such as “payment verified.”, at step 1308. *The Admin Network CC Purchase Module 126 sends the payment to the 3rd Party Network which is equal to the purchase amount received from the 3rd Party Network Discount Module 164 plus or minus any fees that the 3rd Party Network and Admin Network have agreed upon, for example if a $55 drill was purchased in the 3rd Party Network Discount Module 164 and there is an agreed $0.30 transaction fee charged by the Admin Network then the 3rd party would be paid $54.70. at step 1310. *The Admin Network CC Purchase Module 126 stores the data received from the 3rd Party Network Discount Module 164 in the Admin Network CC Transaction Database 136 as a purchase, the data may include a user ID, for example, JS1234, credit card number, for example, 9064 9598 7639 1030, time and date, for example, 6/19/2020 11:30:00 AM, type of transaction, for example an interest charge, transaction amount, for example, $3.21, whether the transaction is pending, whether the transaction was made using an in-network or out-of-network credit card, or any other metric which is usually collected by credit card companies in regards to credit card purchases, payments, or interest fees, in an embodiment, if the user ID was not received from the 3rd Party Network Discount Module 164 then it can be obtained by extracting it from the matching entry in the Admin Network CC User Database 134, at step 1312. *If there is no matching entry in the Admin Network CC User Database 134, the Admin Network CC Purchase Module 126 sends a failed verification notice to the 3rd Party Network Discount Module 164, in an embodiment a verification notice is a simple Boolean true or false statement, in other embodiments it may include other data which may include message for the user or the 3rd Party Network such as “verification error.”, at step 1314.

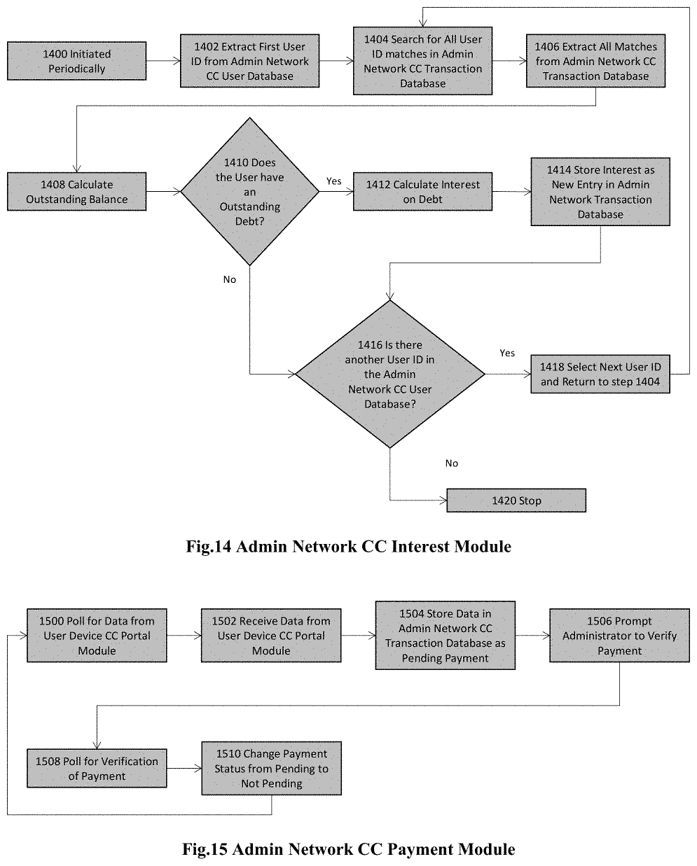

Functioning of the Admin Network CC Interest Module 128 will now be explained with reference to FIG. 14. *The process begins with the Admin Network CC Interest Module 128 being initiated periodically, in some embodiments this initiation may be done by another module, in another embodiment the Admin Network CC Interest Module 128 may poll a database or an internal clock for a time interval, the period chosen is based on when interest should be calculated, for example, hourly, daily, weekly, monthly, etc., at step 1400. *The Admin Network CC Interest Module 128 extracts the first user ID in the Admin Network CC User Database 134, in embodiments where the Admin Network CC Interest Module 128 is run on a different time schedule for individual users the user ID of the user that triggered the initiation of the Admin Network CC Interest Module 128 will be selected, for example, if user A set up a credit card 7 days ago and user B set up a credit card 3 days ago and the interest is calculated weekly then user A will be extracted and user B will not be extracted, then the Admin Network CC Interest Module 128 will be initiated again 4 days later and only user B will be extracted, in an embodiment only users with in-network credit cards will be extracted, at step 1402. *The Admin Network CC Interest Module 128 searches for all entries with matching user IDs in the Admin Network CC Transaction Database 136, entries may include a user ID, for example, JS1234, credit card number, for example, 9064 9598 7639 1030, time and date, for example, 6/19/2020 11:30:00 AM, type of transaction, for example an interest charge, transaction amount, for example, $3.21, whether the transaction is pending, whether the transaction was made using an in-network or out-of-network credit card, or any other metric which is usually collected by credit card companies in regards to credit card purchases, payments, or interest fees, at step 1404. *The Admin Network CC Interest Module 128 extracts all of the matching entries from the Admin Network CC Transaction Database 136, entries may include a user ID, for example, JS1234, credit card number, for example, 9064 9598 7639 1030, time and date, for example, 6/19/2020 11:30:00 AM, type of transaction, for example an interest charge, transaction amount, for example, $3.21, whether the transaction is pending, whether the transaction was made using an in-network or out-of-network credit card, or any other metric which is usually collected by credit card companies in regards to credit card purchases, payments, or interest fees, at step 1406. *The Admin Network CC Interest Module 128 calculates the user's outstanding balance by adding together all the amounts of the user's purchases and interest fees, minus all the payments the user has made, in some embodiments this may not include transactions made within the most current period since this debt would not yet be outstanding or overdue, in some embodiments the calculation may be done by subtracting purchases and interest from payments, adding purchases and interest to payments as negative numbers, etc., in an embodiment, pending transactions are not included, at step 1408. *The Admin Network CC Interest Module 128 determines if the user has any outstanding or overdue debt based on the results of the balance calculation, if not, the Admin Network CC Interest Module 128 moves on to step 1416, at step 1410. *If the user has any outstanding or overdue debt, The Admin Network CC Interest Module 128 calculates the interest on that debt by multiplying the debt by an interest rate, for example, a $100 debt at a 3% interest rate would be $3 of interest, in some embodiments interest rate may be obtained from a database, other module, or some other external source such as a bank, stock market, or website, at step 1412. *The Admin Network CC Interest Module 128 stores the interest on the debt as a new entry in the Admin Network CC Transaction Database 136 along with the user ID extracted from the Admin Network CC User Database 134, in some embodiments other data may be extracted in step 1402 to be stored in this step, for example, credit card number, expiration date, CVC, billing address, etc., at step 1414. *The Admin Network CC Interest Module 128 determines if there is another user ID in the Admin Network CC User Database 134, in some embodiments users may be able to sign up for multiple credit cards, in which case the next user ID may be identical to an already selected user ID, but with a different credit card number, at step 1416. *If there is another user ID in the Admin Network CC User Database 134, The Admin Network CC Interest Module 128 extracts that user ID and returns to step 1404 at step 1418. *If there are no more user IDs that have not already been extracted, the Admin Network CC Interest Module 128 stops, in some embodiments the module will return to polling for a specific time interval to begin again, at step 1420.

Functioning of the Admin Network CC Payment Module 130 will now be explained with reference to FIG. 15. *The process begins with the Admin Network CC Payment Module 130 polling for payment data from the User Device CC Portal Module 154, this data includes at least a user ID and an amount to be paid, in some embodiments payment information may be a bank account routing number, a debit card, another credit card, a PayPal account, a Zelle account, check or money order information, or any other method of paying money, at step 1500. *The Admin Network CC Payment Module 130 receives the payment data from the User Device CC Portal Module 154, this data includes at least a user ID and an amount to be paid, in some embodiments payment information may be a bank account routing number, a debit card, another credit card, a PayPal account, a Zelle account, check or money order information, or any other method of paying money, at step 1502. *The Admin Network CC Payment Module 130 stores the data received from the User Device CC Portal Module 154 in the Admin Network CC Transaction Database 136 as a payment and sets the status of that payment to pending, at step 1504. *The Admin Network CC Payment Module 130 prompt and administrator to verify the payment, an administrator may be, for example, an owner of the Admin Network, a person hired to handle payment approval, or an independent entity that handles credit card payments, in an embodiment the data is sent to another module which can verify the payment automatically, the data may be displayed on a GUI as part of the Admin Network or may be sent to an administrator via email, text, fax, etc., at step 1506. *The Admin Network CC Payment Module 130 polls for a response from the administrator that the payment has been verified, in some embodiments if the payment is not verified a notification is sent to the user, for example “Problem with Credit Card Payment.”, at step 1508. *The Admin Network CC Payment Module 130 changes the pending status of the payment in the Admin Network CC Transaction Database 136 pending category from “Y” to “N” indicating that the payment is no longer pending, at step 1510.

Functioning of the Admin Network CC User Account Module 132 will now be explained with reference to FIG. 16. *The process begins with the Admin Network CC User Account Module 132 polling for a user ID from the User Device CC Portal Module 154, in an embodiment the user may have more than one credit card registered to the same user ID and the Admin Network CC User Account Module 132 would also poll for a credit card number at step 1600. *The Admin Network CC User Account Module 132 receives a user ID from the User Device CC Portal Module 154, for example, HG4837 at step 1602. *The Admin Network CC User Account Module 132 searches the Admin Network CC Transaction Database 136 for all entries that match the user ID received from the User Device CC Portal Module 154 in the user ID category, at step 1604. *The Admin Network CC User Account Module 132 extracts all entries that match the user ID in the Admin Network CC Transaction Database 136, for example, if the same user made a purchase, was charged interest, and then made a payment, all three of those transactions would be extracted, transaction data may include a user ID, for example, JS1234, credit card number, for example, 9064 9598 7639 1030, time and date, for example, 6/19/2020 11:30:00 AM, type of transaction, for example an interest charge, transaction amount, for example, $3.21, whether the transaction is pending, whether the transaction was made using an in-network or out-of-network credit card, or any other metric which is usually collected by credit card companies in regards to credit card purchases, payments, or interest fees, at step 1606. *The Admin Network CC User Account Module 132 sends the extracted entries to the User Device CC Portal Module 154 and returns to polling for a user ID, at step 1608.

Functioning of the Admin Network CC User Database 134 will now be explained with reference to FIG. 17. *The database contains information about users who have a credit card including user ID, for example, JS1234, billing information, for example, 123 Main Street, Boston, Mass., credit card number, for example, 9064 9598 7639 1030, credit card expiration date, for example, 22-June, CVC, for example, 473, code used to sign up, for example, 654123-S012, credit card company, for example, Wells Fargo, and any other identifying information which may be used as part of a credit card application process or is usually collected by credit card companies, for example, a phone number or other contact, this data is used to identify users via either their user ID or credit card number so that when the user makes a purchase the purchase can be correctly recorded and the upline user, if there is one, can be found using the code used to sign up and paid commission accordingly, for example, the user ID and/or credit card number is used by the Admin Network CC Interest Module 128 to find all transactions made by that card in the Admin Network CC Transaction Database 136, and then calculate interest on the outstanding debt.

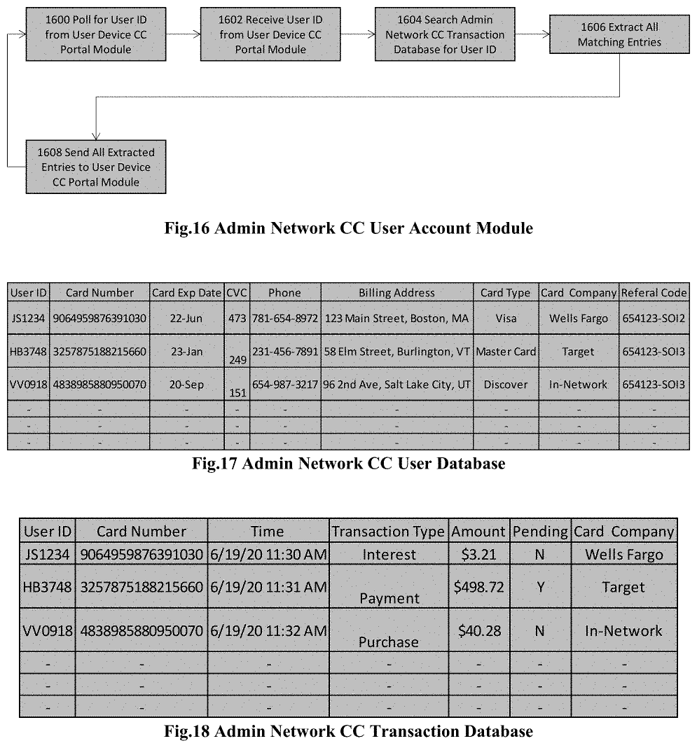

Functioning of the Admin Network CC Transaction Database 136 will now be explained with reference to FIG. 18. *The database contains transactions made by users with credit cards, transactions may include a user ID, for example, JS1234, credit card number, for example, 9064 9598 7639 1030, time and date, for example, 6/19/2020 11:30:00 AM, type of transaction, for example an interest charge, transaction amount, for example, $3.21, whether the transaction is pending, whether the transaction was made using an in-network or out-of-network credit card, or any other metric which is usually collected by credit card companies in regards to credit card purchases, payments, or interest fees, this data is used to determine the user's credit card balance which is used by the Admin Network to charge interest and by the user to view their balance and make payments, for example, these transactions are sent by the Admin Network CC User Account Module 132 to the User Device CC Portal Module 154 so that the user can make a payment, in some embodiments this database may contain more information about the product if the transaction is a purchase.

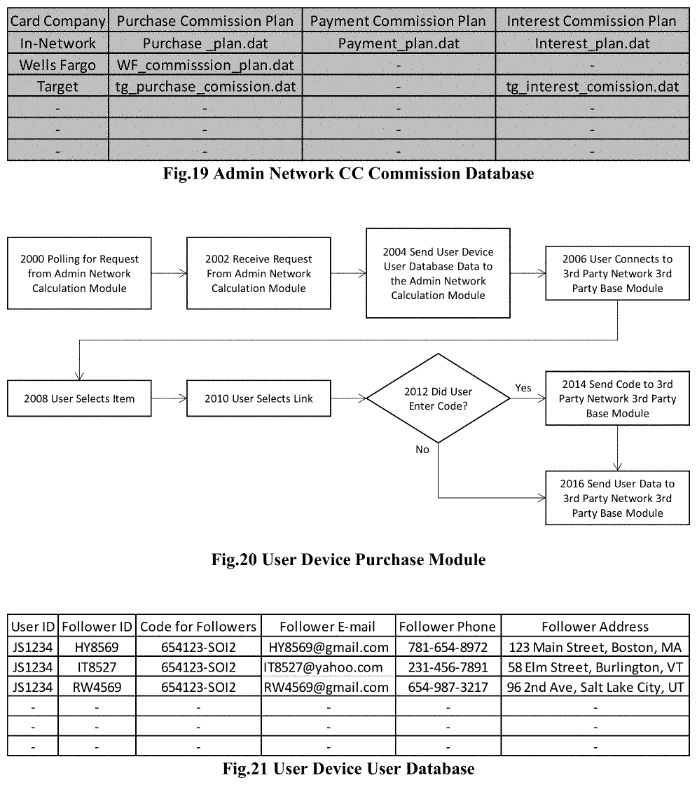

Functioning of the Admin Network CC Commission Database 138 will now be explained with reference to FIG. 19. *The database contains commission plans for each individual credit card company, the plans may treat each type of transaction differently, for example, payments may have a different commission structure than purchases, in some embodiments commission plans may be separated by card type (visa, MasterCard, AmEx), item ID, user ID, sign-up date, etc. In the figure, commission plans are presented as data files as commission plan structures are completely customizable, these commission plans contain a set of instructions to calculate commission, for example, the file Purchase_plan.dat may contain the following code:

If (purchase_Amount <= 50)
commission = Purchase Amount * 0.02f
else if (purchase_Amount > 50 && purchase_Amount <= 1000)
commission = (purchase_Amount - 50) * 0.01f + 1
else
commission = purchase_Amount * (0.01f / log(purchase_Amount)) + 11

a commission plan data file may hold a simple equation that pays upline users at a decaying rate, or may be much more complex involving different commission structures based on the type of product purchased, for example, gas may pay 3% upline at a 50% decay rate where as food purchases may pay 1% upline at a 40% decay rate, the commission plan may give upline users different rewards, for example, frequent flier miles, redeemable points, or store credit, a commission plan may be configured to only pay up to a certain amount across all upline users, or may only pay a certain number of upline users, in an embodiment all plans will have to adhere to a rigid structure which includes an initial percentage and a decay rate, this data is used by the Admin Network CC Commission Module 124 to calculate commissions to be paid to upline users.

Functioning of the User Device Purchase Module 146 will now be explained with reference to FIG. 20. The process begins with the User Device Purchase Module 146 continuously polling for a request from the Admin Network Calculation Module 106 for the User Device User Database 148 data, at step 2000. The User Device Purchase Module 146 receives a request from the Admin Network Calculation Module 106 for the User Device User Database 148 data, at step 2002. Then the User Device Purchase Module 146 sends the User Device User Database 148 data to the Admin Network Calculation Module 106, at step 2004. The User Device Purchase Module 146 connects to the 3rd Party Network 3rd Party Base Module 160, at step 2006. Then the user selects an item from the 3rd Party Network, at step 2008. The user selects the link from the 3rd Party Network, at step 2010. Then the User Device Purchase Module 146 determines if the user entered a code, if not the process continues to sending the data to the 3rd Party Network 3rd Party Base Module 160, at step 2012. If it is determined the user entered a code the User Device Purchase Module 146 sends the code to the 3rd Party Network 3rd Party Base Module 160, at step 2014. The User Device Purchase Module 146 sends the user data to the 3rd Party Network 3rd Party Base Module 160. In some embodiments, the user data may be data to purchase the item such as name, address, billing information, etc. In some embodiments, the user data sent to the 3rd Party Network 3rd Party Base Module 160 may include information from a credit card system. In some embodiments, credit card system may refer to a system that allows cardholders to borrow funds with which to pay for goods and services with the condition that the cardholders pay back the borrowed funds, plus interest, as well as any additional agreed-upon charges, at step 2016.

Functioning of the User Device User Database 148 will now be explained with reference to FIG. 21. This figure displays the User Device User Database 148 which contains the user's followers as well as the follower's information. The User Device User Database 148 contains the user's ID, the followers user's ID, the code provided to the followers, the follower's e-mail address, the follower's phone number, the follower's address. In some embodiments, the User Device User Database 148 may contain the follower's social media information such as Twitter, Instagram, Facebook, etc. In some embodiments, the User Database may contain social media plug-ins for enhanced marketing or social media aggregators. In some embodiments, social media plug ins for enhanced marketing may refer to sharing content with other people through social media platforms, for example a share or like button. In some embodiments, the User Device User Database 148 may contain payment information such as bank accounts, credit card information, PayPal, Venmo, etc. In some embodiments, a user ID or ID Enrollment may refer to a participant enrolling in an MLM product tree through an ID, which is unique to each participant in the MLM system. In some embodiments, social medias aggregators may refer to a tool that allows a person to collate posts and updates from many different social media feeds. It creates an organized view of social posts on a specific topic and are often used to display user-generated content on live social walls.

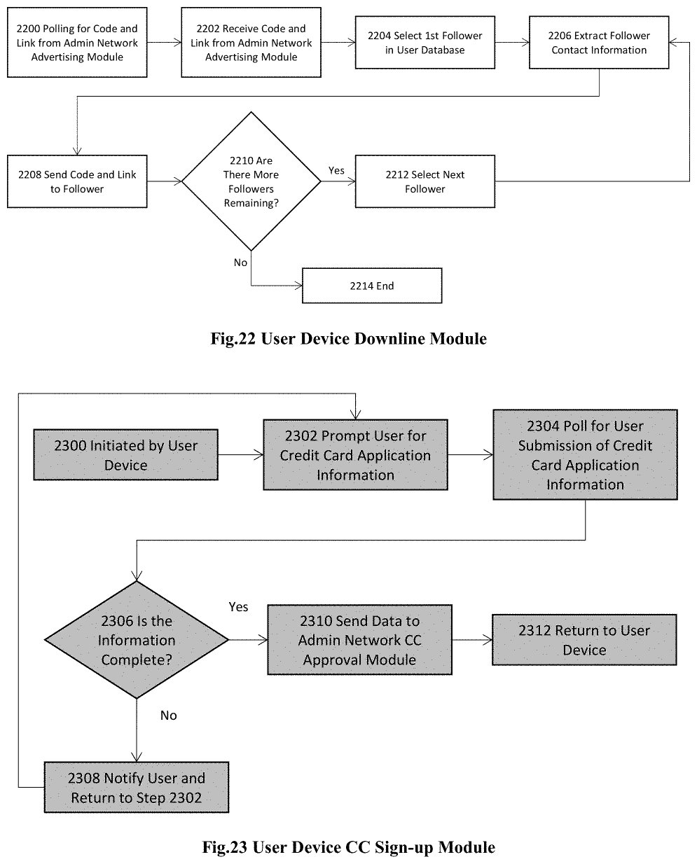

Functioning of the User Device Downline Module 150 will now be explained with reference to FIG. 22. The process begins with the User Device Downline Module 150 continuously polling for the code and the link from the Admin Network Advertising Module 110, at step 2200. The User Device Downline Module 150 receives the code and the link from the Admin Network Advertising Module 110, at step 2202. The User Device Downline Module 150 selects the first follower in the User Device User Database 148, at step 2204. The User Device Downline Module 150 extracts the followers contact information stored in the User Device User Database 148, at step 2206. Then the User Device Downline Module 150 sends the code and link to the follower's contact information. In some embodiments, the code and link may be shared on social media sites, such as Twitter, Instagram, Facebook, etc. for the user's followers to receive the code and link, at step 2208. The User Device Downline Module 150 determines if there are more followers remaining in the User Device User Database 148, at step 2210. If it is determined that there are more followers stored in the User Device User Database 148, the User Device Downline Module 150 selects the next user stored in the User Device User Database 148 and the process returns to step 2206, at step 2212. If the User Device Downline Module 150 determines that there are no more followers remaining in the User Device User Database 148 then the process ends, at step 2214.

Functioning of the User Device CC Sign-up Module 152 will now be explained with reference to FIG. 23. *The process begins with the User Device CC Sign-up Module 152 being initiated by the User Device, in an embodiment this may be done via an interactable button or link on a GUI, for example, a button that says, “Sign-up for a Credit Card Today!”, at step 2300. *The User Device CC Sign-up Module 152 prompts the user for credit card application information, for example, the user's user ID, billing address, full name, social security number, and other information which is usually required to apply for a credit card, in an embodiment this may also serve as ID enrollment, such that a user is granted a user ID when they sign-up for a credit card, or the user ID is tied to the credit card number, in some embodiments the only way to have a user ID and therefore participate in the MLM system is applying for an in-network credit card, at step 2302. *The User Device CC Sign-up Module 152 polls for the user submission of the credit card application data, in an embodiment this may be done by having the user click a button on a GUI, for example, a button that says “Submit”, in other embodiments the data may be pulled directly from a database on the User Device, at step 2304. *The User Device CC Sign-up Module 152 determines if the information is complete by checking if all necessary prompts have been filled out, for example, if the user's billing information is missing then the information is incomplete, in some embodiments the User Device CC Sign-up Module 152 can also determine if a filled out prompt is incomplete, for example, if a zip code is only 4 digits instead of 5 or includes letters instead of only numbers, at step 2306. *If the information is incomplete, the User Device CC Sign-up Module 152 notifies the user that the application is incomplete and returns to step 2302, in some embodiments the User Device CC Sign-up may keep or delete already entered data, in an embodiment the User Device CC Sign-up Module 152 may indicate which prompt is incomplete, at step 2308. *If the information is complete, the User Device CC Sign-up Module 152 sends the submitted data to the Admin Network CC Approval Module 122, at step 2310. *The User Device CC Sign-up Module 152 returns to the User Device, in some embodiments the user may receive a notification that their application has been submitted and is pending approval, at step 2312.

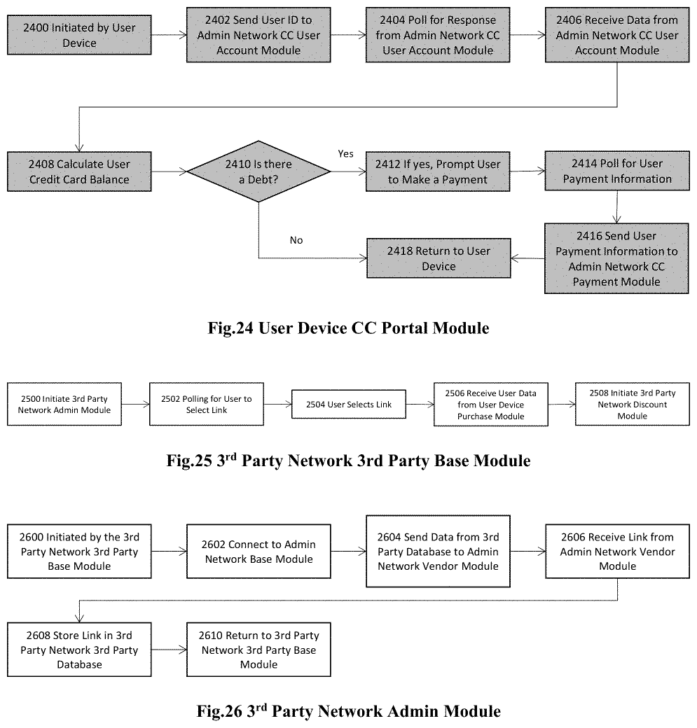

Functioning of the User Device CC Portal Module 154 will now be explained with reference to FIG. 24. *The process begins with the User Device CC Portal Module 154 being initiated by the User Device, in an embodiment this may be done via an interactable button or link on a GUI, for example, a button that says, “View Account Balance”, at step 2400. *The User Device CC Portal Module 154 sends the user's user ID to the Admin Network CC User Account Module 132, in an embodiment the user ID may be entered by the user to gain access to initiate the module, in another embodiment the user ID may be extracted from another module or a database on the User Device, at step 2402. *The User Device CC Portal Module 154 polls for a response from the Admin Network CC User Account Module 132, the response contains transaction data which may include a user ID, for example, JS1234, credit card number, for example, 9064 9598 7639 1030, time and date, for example, 6/19/2020 11:30:00 AM, type of transaction, for example an interest charge, transaction amount, for example, $3.21, whether the transaction is pending, whether the transaction was made using an in-network or out-of-network credit card, or any other metric which is usually collected by credit card companies in regards to credit card purchases, payments, or interest fees, in an embodiment the response may also be an error message indicating that the user has no current transactions, at step 2404. *The User Device CC Portal Module 154 receives user specific data from the Admin Network CC User Account Module 132, transaction data may include a user ID, for example, JS1234, credit card number, for example, 9064 9598 7639 1030, time and date, for example, 6/19/2020 11:30:00 AM, type of transaction, for example an interest charge, transaction amount, for example, $3.21, whether the transaction is pending, whether the transaction was made using an in-network or out-of-network credit card, or any other metric which is usually collected by credit card companies in regards to credit card purchases, payments, or interest fees, at step 2406. *The User Device CC Portal Module 154 calculates the user's credit card balance by adding together all the amounts in the amount category of the user's purchases and interest fees, minus all the payments the user has made, in some embodiments transactions made within the most current period since this debt would be noted as being not outstanding or overdue, in some embodiments the calculation may be done by subtracting purchases and interest from payments, adding purchases and interest to payments as negative numbers, etc., in an embodiment, pending transactions are not included, in some embodiments all the separate transactions in the data obtained from the Admin Network CC User Account Module 132 would be viewable by the user, for example, via a GUI in a formatted table, at step 2408. *The User Device CC Portal Module 154 determines if there is a debt based on the user's credit card balance by checking if the balance is negative, in some embodiments the User Device CC Portal Module 154 may differentiate between a debt that is due at some time in the future and a debt that is overdue, if there is no debt the User Device CC Portal Module 154 Returns to the User Device, at step 2410. *If there is a debt, the User Device CC Portal Module 154 prompts the user to make a payment, in an embodiment this prompt may be imitated by the user via a button or link on a GUI, for example, a “Pay Credit Card Bill” or “Make a Payment” button, at step 2412. *The User Device CC Portal Module 154 polls for the user's payment information which includes at least an amount to be paid, in some embodiment's payment information may be a bank account routing number, a debit card, another credit card, a PayPal account, a Zelle account, check or money order information, or any other method of paying money, at step 2414. *The User Device CC Portal Module 154 sends the user's payment information to the Admin Network CC Payment Module 130, which includes at least the user's user ID and the amount to be paid, but may also include a bank account routing number, a debit card, another credit card, a PayPal account, a Zelle account, check or money order information, or any other method of paying money, at step 2416. *The User Device CC Portal Module 154 returns to the User Device, in some embodiment the user may continue to view their transactions after the module has returned to the User Device, at step 2418.

Functioning of the 3rd Party Network 3rd Party Base Module 160 will now be explained with reference to FIG. 25. The process begins with the 3rd Party Network 3rd Party Base Module 160 initiating the 3rd Party Network Admin Module 162, at step 2500. Then the 3rd Party Network 3rd Party Base Module 160 continuously polls for the user to select the link, at step 2502. The user selects the link on the 3rd Party Network, at step 2504. Then the 3rd Party Network 3rd Party Base Module 160 receives the user data from the User Device Purchase Module 146. In some embodiments, the user data may be data to purchase the item such as name, address, billing information, etc., at step 2506. Then the 3rd Party Network 3rd Party Base Module 160 initiates the 3rd Party Network Discount Module 164, at step 2508.

Functioning of the 3rd Party Network Admin Module 162 will now be explained with reference to FIG. 26. The process begins with the 3rd Party Network Admin Module 162 being initiated by the 3rd Party Network 3rd Party Base Module 160, at step 2600. The 3rd Party Network Admin Module 162 connects to the Admin Network Base Module 104, at step 2602. Then the 3rd Party Network Admin Module 162 sends the 3rd Party Network 3rd Party Database 166 to the Admin Network Vendor Module 114, at step 2604. The 3rd Party Network Admin Module 162 receives the link for the item from the Admin Network Vendor Module 114, at step 2606. Then the 3rd Party Network Admin Module 162 stores the link in the 3rd Party Network 3rd Party Database 166, at step 2608. Then the 3rd Party Network Admin Module 162 returns to the 3rd Party Network 3rd Party Base Module 160, at step 2610.

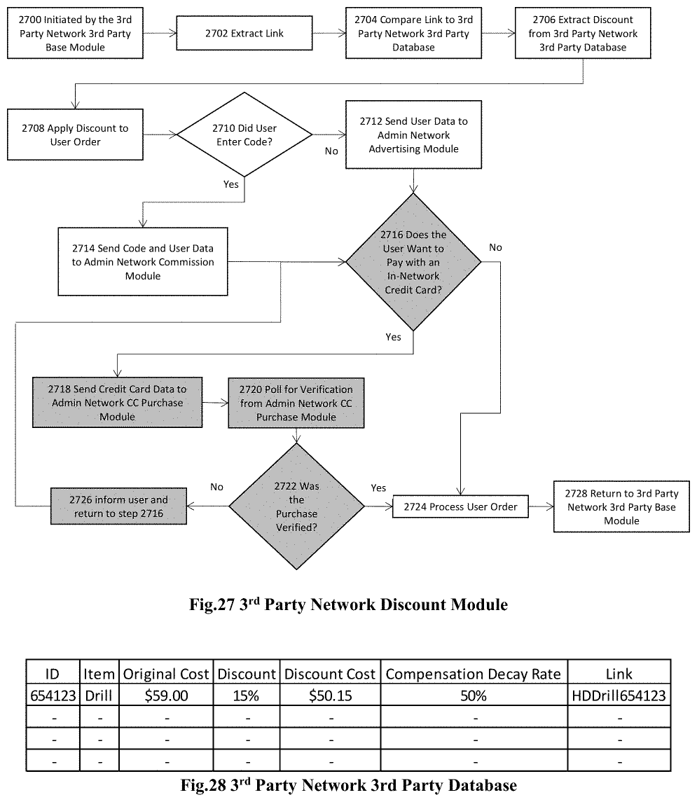

Functioning of the 3rd Party Network Discount Module 164 will now be explained with reference to FIG. 27. The process begins with the 3rd Party Network 3rd Party Base Module 160 initiating the 3rd Party Network Discount Module 164, at step 2700. The 3rd Party Network Discount Module 164 extracts the link received from the user through the process described in the 3rd Party Network 3rd Party Base Module 160, at step 2702. Then the 3rd Party Network Discount Module 164 compares the extracted link to the 3rd Party Network 3rd Party Database 166, at step 2704. The 3rd Party Network Discount Module 164 extracts the corresponding discount using the extracted link from the 3rd Party Network 3rd Party Database 166, at step 2706. Then the 3rd Party Network Discount Module 164 applies the extracted discount to the user's order, at step 2708. The 3rd Party Network Discount Module 164 determines if the user entered a code, at step 2710. If it is determined that the user did not enter a code the 3rd Party Network Discount Module 164 sends the user data to the Admin Network Advertising Module 110, at step 2712. If it is determined that the user entered a code the 3rd Party Network Discount Module 164 sends the code and the user data to the Admin Network Commission Module 108, at step 2714. *The 3rd Party Network Discount Module 164 determines if the user wants to pay with an in-network credit card, in an embodiment this is done via an E-commerce shopping cart which allows the user to select one or more items and then select their method of payment, the user then enters their payment information, which may be credit card information, or the information may be saved from a previous purchase, in some embodiment the user may indicate that the card is in-network, in another embodiment the 3rd Party Network Discount Module 164 may recognize that the card is in-network via a database of known in-network cards, if the user does not want to pay with an in network credit card skip to step 2724, at step 2716. *If the user wants to pay with an in-network credit card, then the 3rd Party Network Discount Module 164 sends the credit card data to the Admin Network CC Purchase Module 126, at step 2718. *Then the 3rd Party Network Discount Module 164 polls for verification data from the Admin Network CC Purchase Module 126, at step 2720. *The 3rd Party Network Discount Module 164 determines if the verification data indicates the card information is legitimate and the purchase has been approved by the Admin Network CC Purchase Module 126 at step 2722. *If the purchase is verified, the 3rd Party Network Discount Module 164 processes the user's order, at step 2724. *If the purchase is unverified, the 3rd Party Network Discount Module 164 informs the user that there was an error verifying their purchase and returns to step 2716, at which point the user may retry or choose a different payment method, at step 2726. Then the 3rd Party Network Discount Module 164 returns to the 3rd Party Network 3rd Party Base Module 160, at step 2728.

Functioning of the 3rd Party Network 3rd Party Database 166 will now be explained with reference to FIG. 28. This figure displays the 3rd Party Network 3rd Party Database 166 which contains the information about the items enrolled in the MLM system as well as the link created by the Admin Network Vendor Module 114. The 3rd Party Network 3rd Party Database 166 contains the item ID, the item, the original cost of the item, the discount provided by the 3rd Party for the item, the cost of the item with the discount, the compensation plan decay rate which the 3rd party enters, and the link received from the Admin Network Vendor Module 114. In some embodiments, the 3rd Party Network 3rd Party Database 166 may include the rates of exchange for product returns, marketing materials, airline sky miles, etc. In some embodiments, product returns may refer to a process in which a customer or consumer takes previously purchased product, merchandise, or goods back to the retailer, and in turn receive a refund in the original form of payment, exchange for another item (identical or different), or a store credit. In some embodiments, the information about the product or service may be advertisements to the network, or as seen on TV sales. Advertisements to the network may refer to the advertisement provided to the MLM system from the 3rd party offering a product, good or service. In some embodiments, as seen on TV sales may refer to a generic nameplate for products advertised on television in the United States for direct response mail-order through a toll-free telephone number. In some embodiments, marketing materials may refer to a means of marketing, advertising or promotional materials developed by or for license (or subject to licensee's approval) that promote the sale of the licensed product, including but not limited to, television, radio and online advertising, point of sale materials (e.g. posters, counter-cards), packaging advertising, print media and all audio or video media. In some embodiments, airline sky miles may refer to a loyalty program offered by airlines and/or credit cards. Typically, consumers accumulate a set amount of miles based on how much is spent on a ticket or a credit card and are also known as frequent flyer miles or travel points.

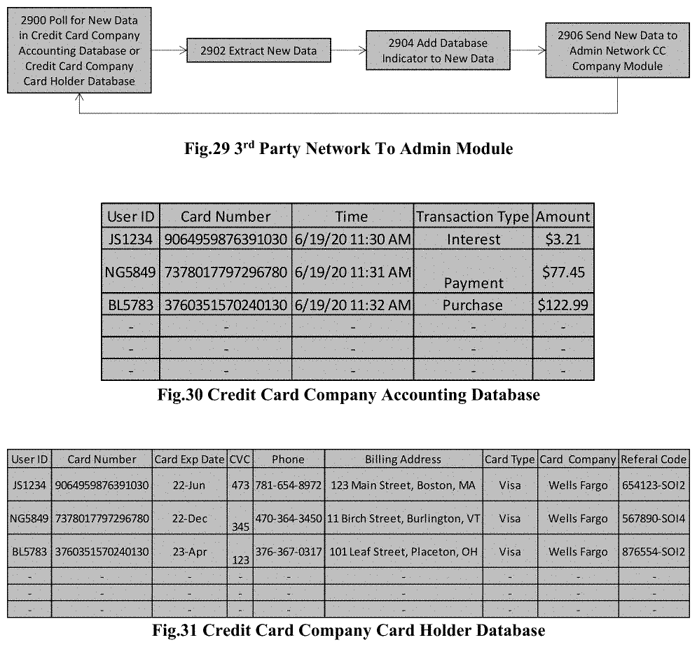

Functioning of the Credit Card Company To Admin Module 172 will now be explained with reference to FIG. 29. *The process begins with the Credit Card Company To Admin Module 172 polling for new data in either the Credit Card Company Accounting Database 174 or the Credit Card Company Card Holder Database 176, data from the Credit Card Company Accounting Database 174 may include a user ID, for example, JS1234, credit card number, for example, 9064 9598 7639 1030, time and date, for example, 6/19/2020 11:30:00 AM, type of transaction, for example an interest charge, transaction amount, for example, $3.21, this data may be used by the Credit Card Company for their own purposes but will also be sent to the Admin Network via the Credit Card Company To Admin Module 172 so that upline users can be compensated for the transactions made by downline users, data from the Credit Card Company Card Holder Database 176 may include a user ID, for example, JS1234, billing information, for example, 123 Main Street, Boston, Mass., credit card number, for example, 9064 9598 7639 1030, credit card expiration date, for example, 22-June, CVC, for example, 473, code used to sign up, for example, 654123-S012, the Credit Card Company, for example, Wells Fargo, and any other identifying information which may be used as part of a credit card application process or is usually collected by credit card companies, for example, a phone number or other contact, at step 2900. *The Credit Card Company To Admin Module 172 extracts the new data from either the Credit Card Company Accounting Database 174 or the Credit Card Company Card Holder Database 176, data from the Credit Card Company Accounting Database 174 may include a user ID, for example, JS1234, credit card number, for example, 9064 9598 7639 1030, time and date, for example, 6/19/2020 11:30:00 AM, type of transaction, for example an interest charge, transaction amount, for example, $3.21, this data may be used by the Credit Card Company for their own purposes but will also be sent to the Admin Network via the Credit Card Company To Admin Module 172 so that upline users can be compensated for the transactions made by downline users, data from the Credit Card Company Card Holder Database 176 may include a user ID, for example, JS1234, billing information, for example, 123 Main Street, Boston, Mass., credit card number, for example, 9064 9598 7639 1030, credit card expiration date, for example, 22-June, CVC, for example, 473, code used to sign up, for example, 654123-S012, the Credit Card Company, for example, Wells Fargo, and any other identifying information which may be used as part of a credit card application process or is usually collected by credit card companies, for example, a phone number or other contact, at step 2902. *The Credit Card Company To Admin Module 172 adds an indicator to the data that indicates which database it originated from, in some embodiments this may be a Boolean, integer, or string that the Admin Network CC Company Module 120 will recognize or can compare to a database, for example, the string “Accounting Database” may indicate the data originates from the Credit Card Company Accounting Database 174, at step 2904. *The Credit Card Company To Admin Module 172 sends the extracted data with the database indicator to the Admin Network CC Company Module 120, data from the Credit Card Company Accounting Database 174 may include a user ID, for example, JS1234, credit card number, for example, 9064 9598 7639 1030, time and date, for example, 6/19/2020 11:30:00 AM, type of transaction, for example an interest charge, transaction amount, for example, $3.21, this data may be used by the Credit Card Company for their own purposes but will also be sent to the Admin Network via the Credit Card Company To Admin Module 172 so that upline users can be compensated for the transactions made by downline users, data from the Credit Card Company Card Holder Database 176 may include a user ID, for example, JS1234, billing information, for example, 123 Main Street, Boston, Mass., credit card number, for example, 9064 9598 7639 1030, credit card expiration date, for example, 22-June, CVC, for example, 473, code used to sign up, for example, 654123-S012, the Credit Card Company, for example, Wells Fargo, and any other identifying information which may be used as part of a credit card application process or is usually collected by credit card companies, for example, a phone number or other contact, at step 2906.

Functioning of the Credit Card Company Accounting Database 174 will now be explained with reference to FIG. 30. *The database contains transactions made by users who obtained a credit card from the Credit Card Company using a referral code from the Admin Network Code Database 118, transactions may include a user ID, for example, JS1234, credit card number, for example, 9064 9598 7639 1030, time and date, for example, 6/19/2020 11:30:00 AM, type of transaction, for example an interest charge, transaction amount, for example, $3.21, this data may be used by the Credit Card Company for their own purposes but will also be sent to the Admin Network via the Credit Card Company To Admin Module 172 so that upline users can be compensated for the transactions made by downline users.

Functioning of the Credit Card Company Card Holder Database 176 will now be explained with reference to FIG. 31. *The database contains the credit card information and personal information of users who obtained a credit card from the Credit Card Company using a referral code from the Admin Network Code Database 118 and may include a user ID, for example, JS1234, billing information, for example, 123 Main Street, Boston, Mass., credit card number, for example, 9064 9598 7639 1030, credit card expiration date, for example, 22-June, CVC, for example, 473, code used to sign up, for example, 654123-S012, the Credit Card Company, for example, Wells Fargo, and any other identifying information which may be used as part of a credit card application process or is usually collected by credit card companies, for example, a phone number or other contact, this data is used to identify users via either their user ID or credit card number so that when the user makes a purchase the purchase can be correctly recorded and the upline user, if there is one, can be found using the code used to sign up and paid commission accordingly, in some embodiments this database may contain more information than is needed by the admin network in which case the Credit Card Company To Admin Module 172 or another module will filter out the unneeded information, this data may be used by the Credit Card Company for their own purposes but will also be sent to the Admin Network via the Credit Card Company To Admin Module 172 so that upline users can be compensated for the transactions made by downline users.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A “single product tree” multi-level marketing method, comprising the steps of,
providing an MLM system with a seller's commission structure, and
providing at least one seller of a product with its associated commission structure, and
providing a plurality of buyers/distributors, and
providing a at least one credit card company, and
allowing the user to sign up for a credit card issued by the MLM system, and allowing the at least one first seller to enroll an at least one product to the MLM system, and
allowing at least a first buyer/distributor to purchase the at least one product, and
allowing at least a second buyer/distributor to buy the advertised product, and
allowing at least one product enrolled in the MLM system to be a credit card issued by the credit card company, and
wherein, the credit card company sets a commission structure for a credit card, enrolls the credit card into the MLM system, allowing the first, second and so on purchasers/distributors to sign up for and then advertise the credit card, and allowing the purchasers/distributors to receive a commission based upon the seller's credit card commission structure,
